(19) United States
(12) Patent Application Publication
(10) Pub. No.: US 2024/0086855 A1
(43) Pub. Date: Mar. 14, 2024

(54) SYSTEMS AND METHODS FOR PROVIDING TIME MANAGEMENT SERVICES

(71) Applicant: L2 Source, LLC, Cincinnati, OH (US)

(72) Inventors: Steven S. Shoemaker, Cincinnati, OH (US); Timothy Clay Campbell, Cincinnati, OH (US)

(21) Appl. No.: 18/466,526

(22) Filed: Sep. 13, 2023

Related U.S. Application Data
(60) Provisional application No. 63/406,327, filed on Sep. 14, 2022.

(51) Int. Cl. G06Q 10/1091

(52) U.S. Cl. CPC G06Q 10/1091

(57) ABSTRACT

A method for managing timesheet information of a contingent laborer is disclosed. The method includes receiving a request to access a timesheet application. The method further includes verifying a user identifier of the contingent laborer. The method further includes obtaining timesheet information of the contingent laborer from an application server. The method further includes providing the timesheet information of the contingent laborer for display on a user interface. The method further includes predicting whether the contingent laborer is clocking-in or clocking-out based at least in part on the timesheet information. The method further includes updating, based on the prediction, the user interface of the timesheet application to accentuate either a clock-in button or a clock-out button. The method further includes receiving a clock value and generating a time-entry record based on the clock value. The method further includes providing the time-entry record to the application server.

### RELATED APPLICATION

This application claims priority to U.S. Provisional Patent Application Ser. No. 63/406,327 filed Aug. 14, 2022, entitled “Systems and Methods for Providing Time Management Services to a Vendor Management System (VMS),” the disclosure of which is hereby incorporated herein by reference, in its entirety.

### BACKGROUND

A vendor management system (VMS) is a cloud platform that provides software-driven services to assist organizations with hiring an external workforce, training the external workforce, and/or managing the external workforce. The external workforce may, for example, be comprised of contingent laborers that have temporary employment contracts with the organization, such as contractors, consultants, and/or the like. In some situations, the VMS may provide timekeeping functionality that assists in tracking time worked by one or more members of the external workforce.

### SUMMARY

In an aspect of the invention, a method for managing timesheet information of a contingent laborer is disclosed. The method includes receiving, by a user device, a request to access a timesheet application. The request includes a user identifier of the contingent laborer. The method further includes verifying, by the user device, the user identifier of the contingent laborer. The method further includes obtaining, by the user device, timesheet information of the contingent laborer from an application server. The timesheet information includes one or more time-entry records for one or more shifts that the contingent laborer has worked in a given time period. The method further includes providing the timesheet information of the contingent laborer for display on a user interface of the user device. The method further includes predicting, by the user device, whether the contingent laborer is clocking-in or clocking-out based at least in part on the timesheet information of the contingent laborer. The method further includes updating, by the user device and based on the prediction, the user interface of the timesheet application to accentuate either a clock-in button or a clock-out button. The method further includes receiving, by the user device, a clock value indicating a time during which the contingent laborer is clocking-in or clocking-out. The method further includes generating, by the user device, a time-entry record based on the clock value. The method further includes providing, by the user device, the time-entry record to the application server such that the user device and the application server have updated timesheet information for the contingent laborer.

In an embodiment of the invention, the application server supports a vendor management system (VMS) that is a single source of authority for the timesheet information of the contingent laborer.

In another embodiment of the invention, the method further includes obtaining, from the application server, profile information for a group of contingent laborers scheduled to work at a worksite. The profile information includes a set of user identifiers where each user identifier corresponds to a respective contingent laborer. The method further includes storing the profile information for the group of contingent laborers locally on the user device. When verifying the user identifier, the method includes verifying the user identifier of the contingent laborer based on determining that the user identifier matches a corresponding stored user identifier of the set of user identifiers.

In another embodiment of the invention, when predicting whether the contingent laborer is clocking-in or clocking-out, the method includes identifying two clock values that represent the two most recent clock values included in the one or more time-entry records. Next, the method includes determining whether a difference in time between the two most recent clock values is greater than a first threshold amount of time. If the difference in time is greater than the first threshold amount of time, the method includes predicting that the contingent laborer is clocking-in. If the difference in time is not greater than the first threshold amount of time, the method includes determining whether a time identified by a most recent clock value is within a second threshold amount of time of a current time, and predicting whether the contingent laborer is clocking-in or clocking-out based on determining whether the time identified by the most recent clock value is within the second threshold amount of time of the current time.

In another embodiment of the invention, when predicting whether the contingent laborer is clocking-in or clocking-out, the method includes identifying a most recent clock value included in the one or more time-entry records. Next, the method includes determining whether a difference in time between the most recent clock value and a current time clock value is greater than a threshold amount of time. Next, the method includes predicting whether the contingent laborer is clocking-in or clocking-out based at least in part on determining whether the difference in time is greater than the threshold amount of time.

In another embodiment of the invention, when predicting whether the contingent laborer is clocking-in or clocking-out, the method includes incorrectly predicting whether the contingent laborer is clocking-in or clocking-out. In this embodiment, assume that the clock value indicating the time during which the contingent laborer is clocking-in or clocking-out corresponds to whichever of the clock-in button or clock-out button is not accentuated on the user interface. In this case, the method further includes determining that a timekeeping discrepancy is present based on receiving the clock value that corresponds to whichever of the clock-in button or clock-out button is not accentuated on the user interface. The method further includes generating an exception message for the timekeeping discrepancy. The method further includes providing the exception message to a device or account of a user authorized to correct the timekeeping discrepancy.

In another embodiment of the invention, the method further includes periodically providing ping messages to the application server to cause the application server to update an administrator user interface of the timesheet application such that said updated administrator user interface displays information indicative of whether a network at a worksite is down.

In another embodiment of the invention, the method further includes appending the time-entry record to a list that includes the one or more time-entry records for the one or more shifts that the contingent laborer has worked in the given time period. In this embodiment, when providing the time-entry record to the application server, the method includes providing the application server with the list that includes the appended time-entry record such that the application server has real-time access to updated timesheet information of the contingent laborer.

In another aspect of the invention, a user device is disclosed. The user device includes a memory storing instructions and a processor. The processor is to receive a user identifier of the contingent laborer. The processor is further to verify the user identifier of the contingent laborer. The processor is further to obtain timesheet information of the contingent laborer from an application server. The timesheet information includes one or more time-entry records for one or more shifts that the contingent laborer has worked in a given time period. The processor is further to provide the timesheet information of the contingent laborer for display on a user interface. The processor is further to predict whether the contingent laborer is clocking-in or clocking-out based at least in part on the timesheet information of the contingent laborer. The processor is further to update, based on the prediction, the user interface of the timesheet application to accentuate either a clock-in button or a clock-out button. The processor is further to receive a clock value indicating a time during which the contingent laborer is clocking-in or clocking-out. The processor is further to generate a time-entry record based on the clock value. The processor is further to provide the time-entry record to the application server such that the user device and the application server have updated timesheet information for the contingent laborer.

In another aspect of the invention, a non-transitory computer-readable medium is disclosed. The non-transitory computer-readable medium stores one or more instructions that, when executed by a processor of a device, cause the processor to receive a request to access a timesheet application. The request includes a user identifier of the contingent laborer. The one or more instructions further cause the processor to verify the user identifier of the contingent laborer. The one or more instructions further cause the processor to obtain timesheet information of the contingent laborer from an application server. The timesheet information including one or more time-entry records for one or more shifts that the contingent laborer has worked in a given time period. The one or more instructions further cause the processor to provide the timesheet information of the contingent laborer for display on a user interface. The one or more instructions further cause the processor to predict whether the contingent laborer is clocking-in or clocking-out based at least in part on the timesheet information of the contingent laborer. The one or more instructions further cause the processor to update, based on the prediction, the user interface of the timesheet application to accentuate either a clock-in button or a clock-out button. The one or more instructions further cause the processor to receive a clock value indicating a time during which the contingent laborer is clocking-in or clocking-out. The one or more instructions further cause the processor to generate a time-entry record based on the clock value. The one or more instructions further cause the processor to provide the time-entry record to the application server such that the user device and the application server have updated timesheet information for the contingent laborer.

### BRIEF DESCRIPTION OF THE DRAWINGS

FIGS. 1A-1I are diagrams of one or more example embodiments described herein.

FIG. 2 is a diagram of an example environment in which systems and/or methods described herein may be implemented.

FIG. 3 is a diagram of example components of one or more devices of FIG. 2.

### DETAILED DESCRIPTION

The following detailed description of example embodiments refers to the accompanying drawings. The same reference numbers in different drawings may identify the same or similar elements.

A VMS is a cloud platform that provides software-driven services to assist organizations with hiring, training, and/or managing of an external workforce. The external workforce often includes contingent laborers (e.g., contractors, consultants, and/or the like). In some situations, a VMS may provide an interface to dozens of organizations that deal with thousands of contingent laborers. A filtering and selection process may occur that involves providing an organization with a list of contingent laborers who are available to work on a given day. In some cases, the VMS may be used to screen contingent laborers. Additionally, the VMS may support the database used to store the credentials of contingent laborers and may further assist with recording timekeeping entries of the contingent laborers.

However, a VMS may encounter problems when there is a large number of contingent laborers. First, problems arise when delivering credentials to the contingent laborers. Specifically, to work at a new worksite, a contingent laborer may have to obtain credentials, such as an ID card, a key fob or other electronic device, a username and password, and/or the like. If there are thousands of contingent labors, and each contingent laborer has to obtain new credentials when visiting a new worksite, there may be contingent laborers who are unclear on how to properly obtain their credentials, contingent laborers who forget to obtain their credentials, contingent laborers who obtain but then lose their credentials, and/or contingent laborers who obtain but then forget their credentials. Each of these situations may cause problems that prevent (or hinder) contingent laborers from being able to properly provide their credentials to the VMS. For example, a contingent laborer who has forgotten their ID card or username and password may be unable to access an electronic timeclock to begin a shift at the new worksite. To provide another example, a contingent laborer who has forgotten their ID card or username and password may have to engage in a credentialing reset procedure to obtain new credentials needed to access the timeclock.

Second, a VMS may have problems with accurately capturing and/or recording the work performed by the contingent laborers. For example, if thousands of contingent laborers are accessing the VMS to input time entries, and a subset of those contingent laborers are encountering issues with their credentials, a substantial number of timesheet records stored by the VMS may not accurately reflect the hours worked by each respective contingent laborer.

Some embodiments described herein include a user device that communicates with a time management platform to correct and/or improve upon the problems described above. For example, the user device may support a timesheet application and a contingent laborer may obtain a user identifier used to access the timesheet application. The user identifier may, for example, be a code that is known to the user, such as a 4-digit code, an 8-digit code, a 12-digit code, and/or the like. To provide a specific example, the user identifier may be an 8-digit code where the first two digits are a birth month of the contingent laborer, the next two digits are a birth day of the contingent laborer, and the final four digits are the last four digits of a social security number of the contingent laborer. The user identifier is not assigned, but rather is a value already known to the contingent laborer. Using a known user identifier to credential the contingent laborer resolves one or more of the credentials problems described above.

As will be described in detail further herein, after the contingent laborer has obtained their user identifier, the user device may, using the timesheet application, assist the contingent laborer in efficiently and effectively capturing and recording timesheet entries. This solution utilizes the time management platform as the database used to store data relating to credentialing, capturing, and error-checking. Furthermore, the solution is implemented such that no outside storage, processing, authentication, or transaction logging is used.

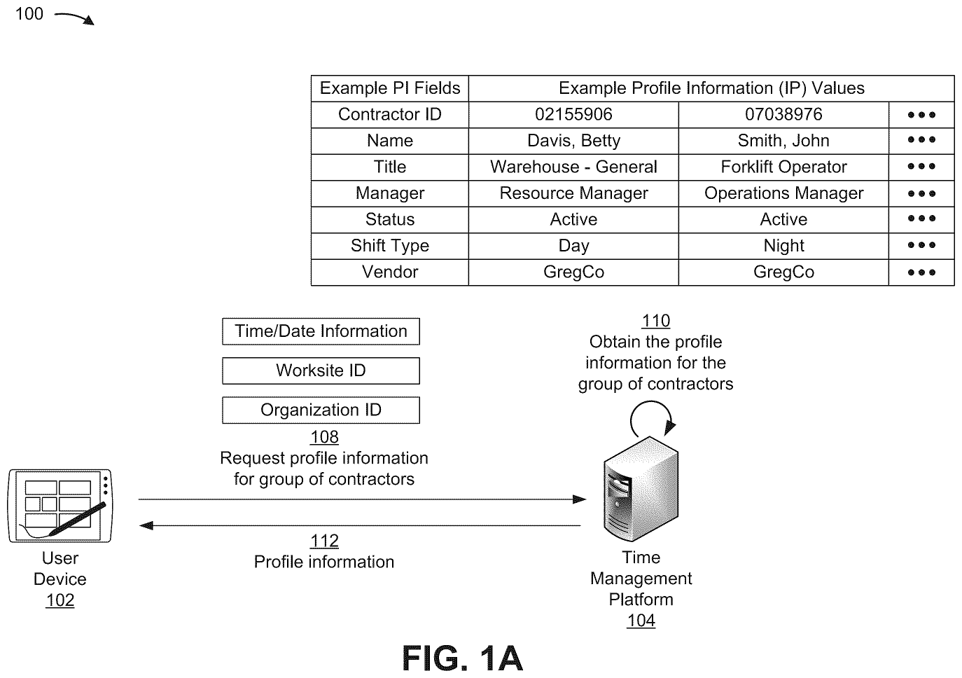

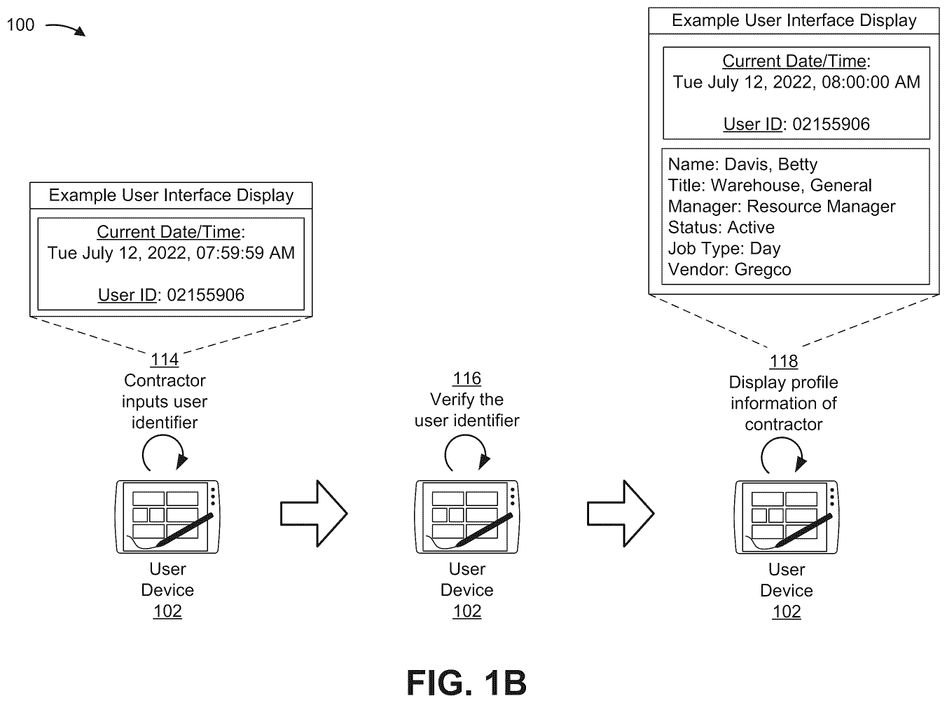

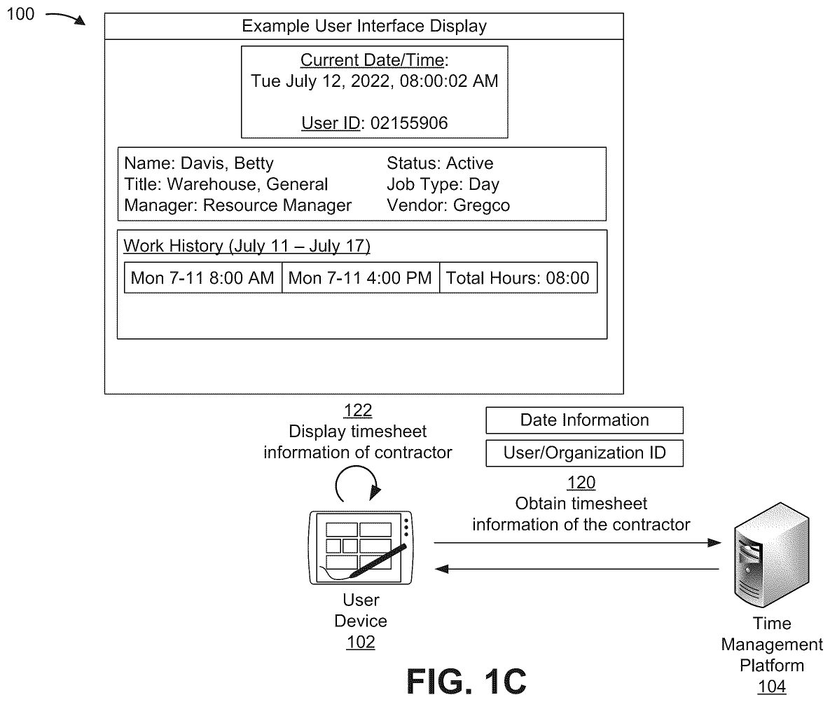

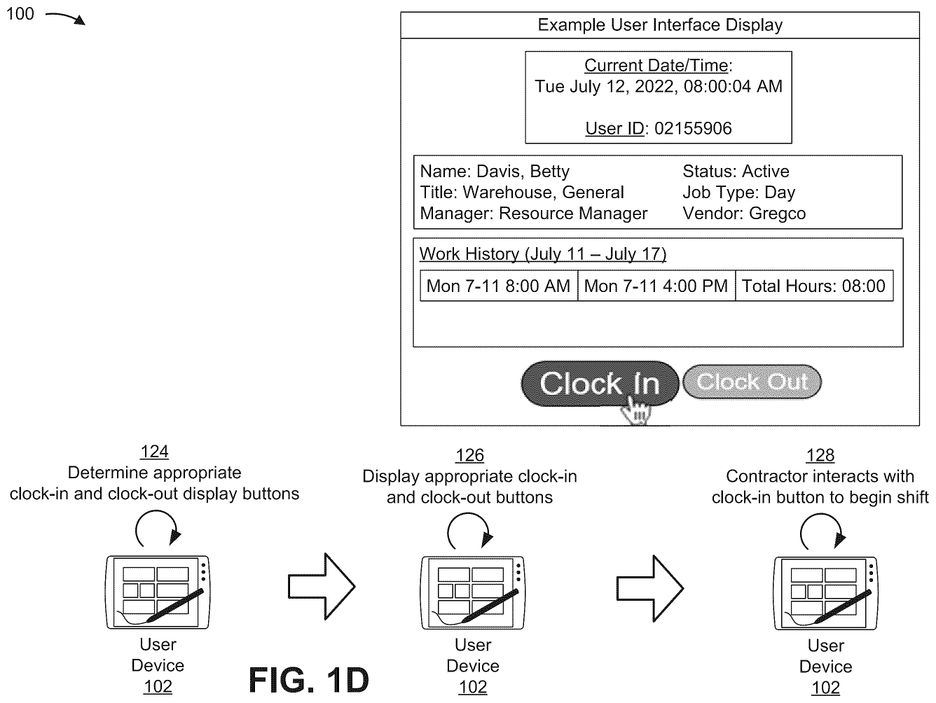

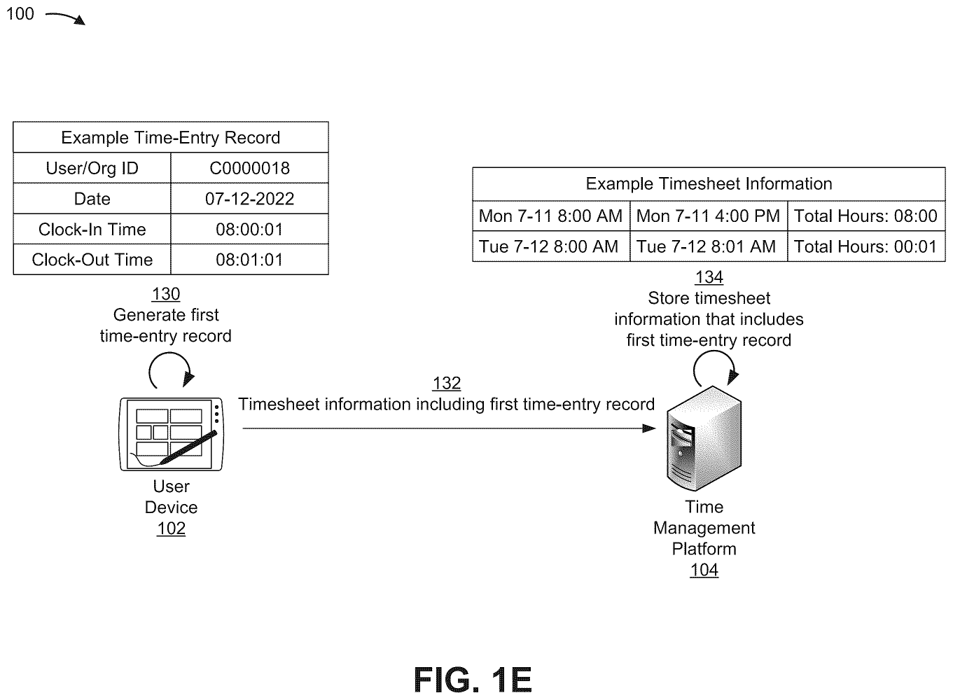

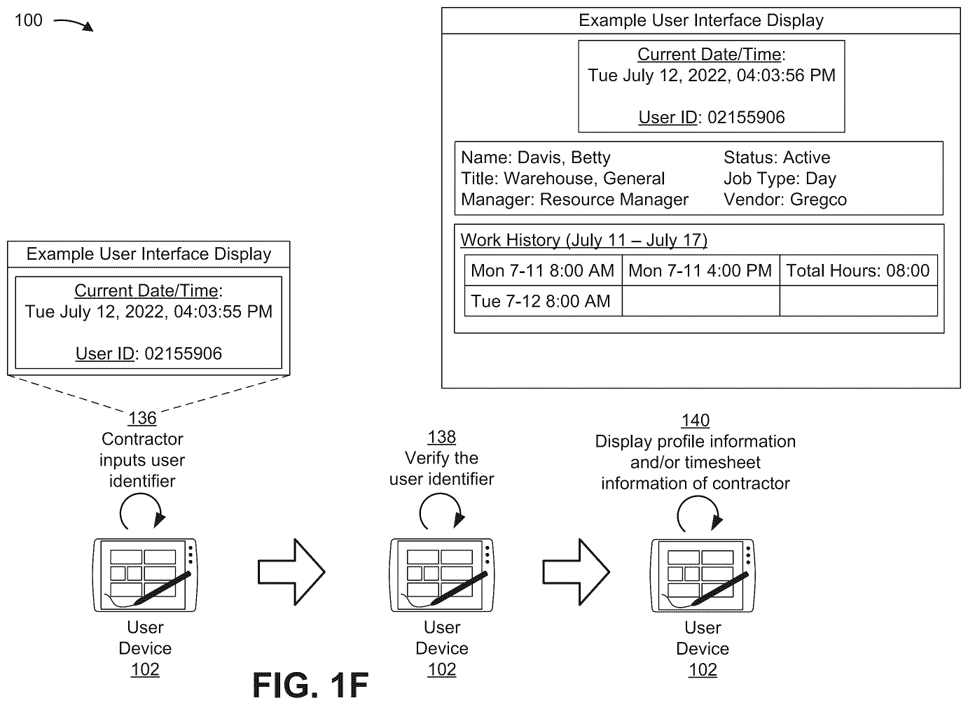

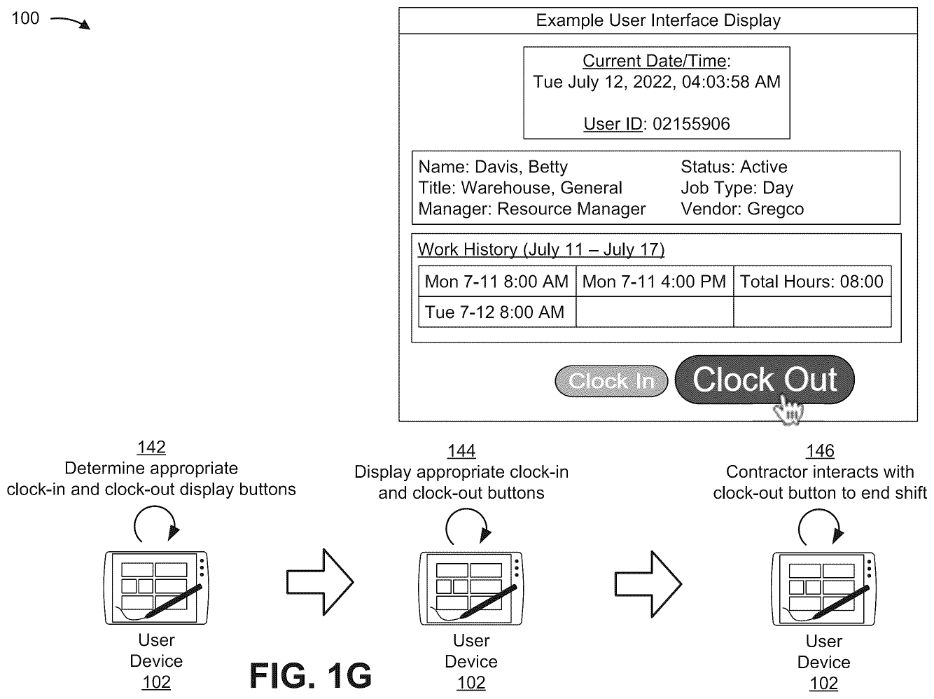

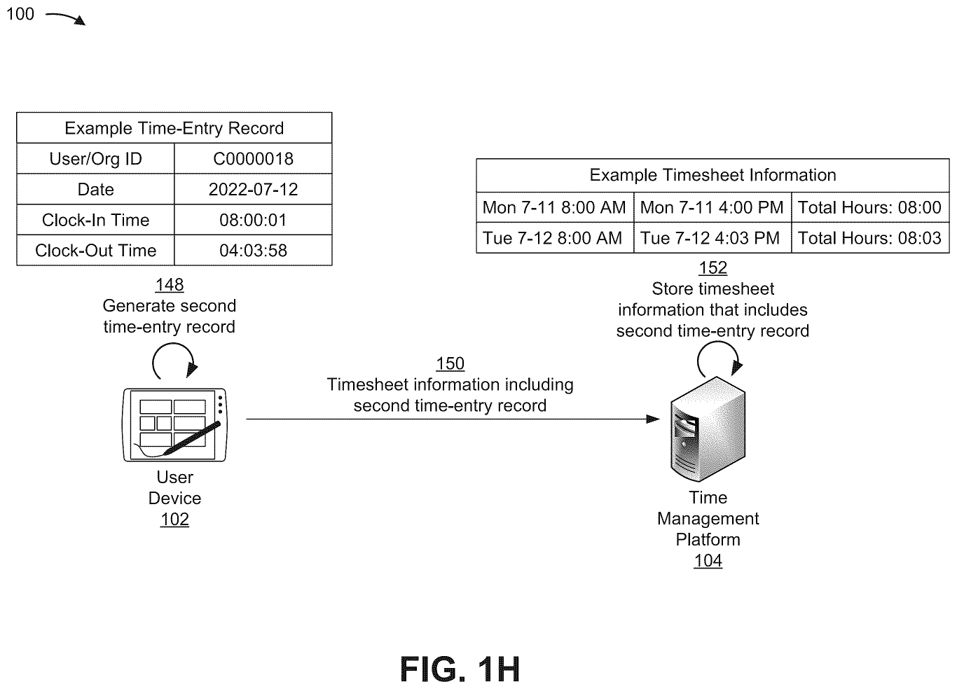

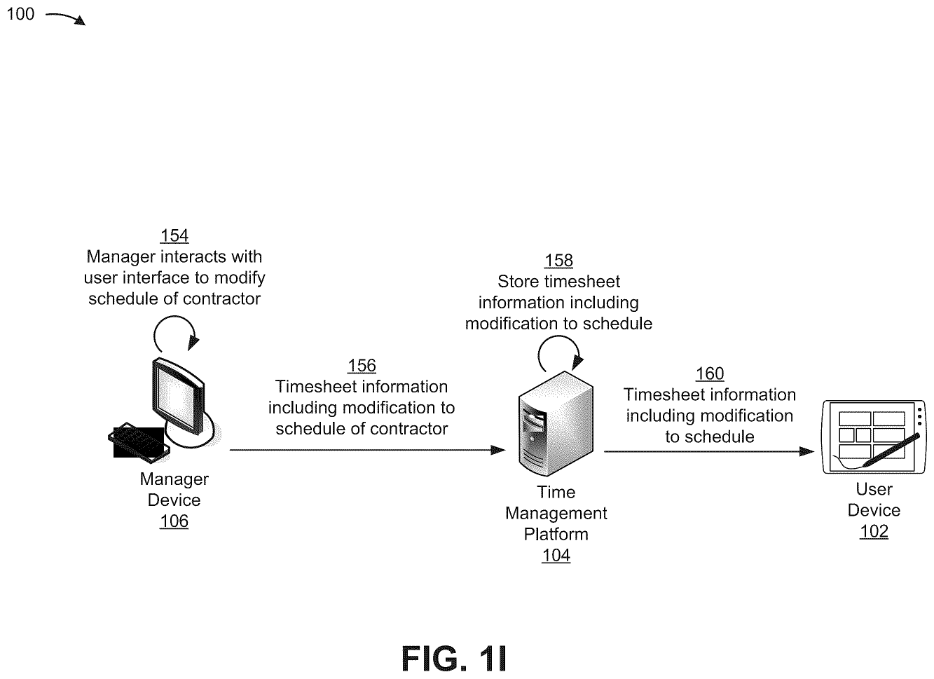

FIGS. 1A-1I are diagrams of one or more example embodiments 100 described herein. Example embodiment(s) 100 may include a user device 102, a time management platform 104, and a manager device 106. As will be shown in FIGS. 1A-1I, the user device 102 may use a timesheet application to assist a contractor with accurately inputting the time the contractor works during a shift at a worksite. This assistance may be provided regardless of the VMS that is being utilized by a vendor organization that has hired the contractor and regardless of whether the VMS has application programming interfaces (APIs) available to assist in timekeeping-related services.

The user device 102 may be a tablet computer (e.g., an iPad or a similar type of device), a mobile phone (e.g., a smart phone, a radiotelephone, etc.), a laptop computer, a handheld computer, a server computer, a gaming device, a wearable communication device (e.g., a smart wristwatch, a pair of smart eyeglasses, etc.), or a similar type of device. In some embodiments, the user device 102 may be a device that is located within the worksite. In some embodiments, a group of user devices 102 may be located within the worksite and each respective user device 102 may support the timesheet application.

The time management platform 104 may include one or more server devices that support a system used for hiring, training, and/or managing a workforce. In some embodiments, the time management platform 104 may be a vendor management system (VMS). In some embodiments, the time management platform 104 may be a component of a VMS. In some embodiments, the time management platform 104 may be another system (or component thereof) used for hiring, training, and/or managing a workforce, such as a contract service management (CSM) system, an enterprise management (EM) system, and enterprise resource planning (ERP) system, and/or the like.

The manager device 106 may be a desktop computer, a tablet computer (e.g., an iPad or a similar type of device), a mobile phone, a laptop computer, and/or another type of device. In some embodiments, the manager device 106 may be a device located within the worksite or that has remote access to a server supporting the worksite. In some embodiments, a group of manager devices 106 may be located within the worksite (and/or have remote access to the server supporting the worksite) and each respective manager device 106 may support the timesheet application.

As shown in FIG. 1A, and by reference number 108, the user device 102 may provide a request for profile information to the time management platform 104. For example, the user device 102 may provide the time management platform 104 with a request for profile information for a group of contractors that are scheduled to work at a worksite over a given time period (e.g., a day, a week, a month, etc.). The request may be provided over a communication interface such as a network (e.g., a cellular network, a private network, the Internet, and/or the like).

The request for the profile information may include an organization identifier corresponding to the organization (e.g., the organization that has hired the contractor to perform a job or task), a worksite identifier corresponding to the worksite, time/date information indicating a time period within which the profile information is being requested for, and/or the like. The profile information being requested may, for each respective contractor, include information indicating a name of the contractor, information indicating a title of the contractor, information indicating a manager of the worksite that the contractor is scheduled to work at, information indicating a status of the contractor (e.g., active, inactive, etc.), information indicating a type of shift to be worked by the contractor (e.g., day shift, night shift, etc.), information indicating a name of a vendor or organization that has employed the contractor, and/or the like. Additionally, or alternatively, the profile information may include user identifiers corresponding to the contractor (e.g., a user identifier and a user/organization identifier).

In some embodiments, a user (e.g., a system administrator, a worksite manager, etc.) may interact with the user device 102 to cause the user device 102 to generate and provide the time management platform 104 with the request for profile information. For example, a worksite manager may interact with the user device 102 to log into the timesheet application and may interact with an interface of the timesheet application to request profile information for a group of contractors that are scheduled to work at the worksite for a given time period (e.g., the upcoming work week). The worksite manager may input an organization identifier of the organization and/or a worksite identifier of the worksite when submitting the request. In some embodiments, the worksite manager may further input date information or a time range that indicates a time period within which the profile information is being requested. For example, the worksite manager may input a current date as a start date and a date of one week later as an end date to request profile information for contractors scheduled to work at the worksite during the upcoming week. In some embodiments, the date information or time range may be configured such that the user only has to input an organization identifier and/or a worksite identifier.

In some embodiments, the user device 102 may be configured to automatically generate and provide the time management platform 104 with the request for profile information. For example, the user device 102 may be configured to generate and provide the time management platform 104 with the request for profile information at a predetermined time period (e.g., once a week, once a month, and/or the like).

As shown by reference number 110, the time management platform 104 may obtain the profile information for the group of contractors that are scheduled to work at the worksite. For example, the time management platform 104 may, based on receiving the request, obtain the profile information by referencing a data structure that associates the worksite identifier for the worksite (and/or the organization identifier) with the profile information of each respective contractor scheduled to work at that worksite. In the example shown, the profile information may include profile information for Betty Davis, John Smith, and any other contractor scheduled to work at the worksite over the given time period.

In some cases, the time management platform 104 may be configured to obtain profile information for a predetermined time period (e.g., a week, a month, etc.). In other cases, the request may include date information specifying a time period, and the time management platform 104 may obtain profile information for all contractors with jobs or tasks scheduled within the specified time period.

As shown by reference number 112, the time management platform 104 may provide the profile information to the user device 102. For example, the time management platform 104 may use the communication interface to provide the user device 102 with the profile information for the group of contractors that are scheduled to work at the worksite during the given time period.

In some embodiments, the user device 102 may store the profile information. For example, the user device 102 may store the profile information locally, such that the profile information may be accessible and/or displayed via the timesheet application.

In some embodiments, the organization may have a group of user devices 102 available at the worksite. In this case, each respective user device 102 may obtain the profile information in the manner described above. In some embodiments, one user device 102, of the group of user devices 102, may obtain the profile information in the manner described above, and may use a local network to transmit the profile information to each of the other user devices 102. In this way, network resources are conserved relative to having each user device 102 obtain the profile information by separately requesting the profile information from the time management platform 104. In some embodiments, each contractor will have access to one user device 102. In some embodiments, several user devices 102 may be made accessible to a group of contractors and each respective contractor may use any of the user devices 102 to access the timesheet application.

As shown in FIG. 1B, and by reference number 114, a contractor may interact with the user device 102 to input a user identifier. For example, a contractor may visit the worksite to begin working at a scheduled time period. The user device 102 may be running the timesheet application and the contractor may interact with a user interface of the timesheet application to input a user identifier. In some embodiments, the user identifier may be a code that is unique to the contractor. For example, the user identifier may be a numeric code, an alphanumeric code, and/or another type of code. To provide a specific example, the user identifier may be an 8-digit code where the first two digits are a birth month of the contractor, the second two digits are a birth day of the contractor, and the final four digits are the last four digits of a social security number of the contractor. In the example shown, the contractor inputs “02155906” as the user identifier. This may be the user identifier based on the contractor having a birth day of February 15^{th}, with the final four digits corresponding to the final four digits of the contractor's social security number. In this way, the user identifier is not assigned, but rather is a value already known to the contractor.

As shown by reference number 116, the user device 102 may verify the user identifier. For example, the user device 102 may verify the user identifier by comparing the user identifier input by the contractor with user identifiers for the group of contractors (e.g., which are included in the profile information received from the time management platform 104). In this case, the user device 102 may verify the user identifier based on determining that the user identifier input by the contractor matches a corresponding user identifier that is stored in association with other profile information of the contractor.

In some embodiments, the user device 102 may fail to verify the user identifier. For example, if the contractor mistakenly inputs the wrong user identifier, the user device 102 may compare the user identifier input by the contractor with stored user identifiers for the group of contractors and may determine that the user identifier input by the contractor does not match any of the stored user identifiers. In this case, the user device 102 may prompt the contractor to re-enter the user identifier. By performing a local verification of the user identifier, the user device 102 conserves network resources relative to a system that requires transmitting data over a network in order to verify the user identifier.

As shown by reference number 118, the user device 102 may display the profile information of the contractor. For example, the user device 102 may display the profile information of the contractor based on successfully verifying the user identifier of the contractor. In the example shown, the user interface may display the profile information of Betty Davis, including her name, title, manager, status, job type, and vendor organization.

As shown in FIG. 1C, and by reference number 120, the user device 102 may obtain timesheet information of the contractor from the time management platform 104. For example, the user device 102 may provide, to the time management platform 104 and via the communication interface, a request for the timesheet information of the contractor.

The request may include a user/organization identifier that is unique to the user/organization pair and date information used to identify a time period in which timesheet information is being requested. For example, the date information may identify a start date (e.g., Monday, June 27^{th}) and/or an end date (e.g., Friday, July 1^{st}) such that timesheet information being requested includes timesheet information for any shifts worked and/or scheduled to be worked within the identified time period. In some cases, the date information included in the request may include only the start date and the time management platform 104 may be configured to provide timesheet information for a fixed time period after the start date identified in the request (e.g., a week, a month, etc.).

The timesheet information of the contractor may include one or more time-entry records. A time-entry record may include a user/organization identifier, date information indicating a date on which the contractor is scheduled to work, information indicating a start time and an end time for a shift, and/or the like. In some embodiments, the contractor may have a time-entry record corresponding to each shift worked by the contractor. In some embodiments, the contractor may have a timesheet record corresponding to each clock-in/clock-out pair input by the contractor. For example, the contractor may clock-in to work in the morning, clock-out during a lunch break, clock-in after the lunch break, and clock-out at the end of the day. In this case, the contractor would have two time-entry records for the shift (e.g., two clock-in/clock-out pairs). In some embodiments, the contractor may have a time-entry record for corresponding to each interaction with the timesheet application. For example, the contractor may have a time-entry record for clocking-in at the start of a shift and may have a separate time-entry record for clocking-out at the end of the shift. The timesheet information may represent a current copy of the contractor's timesheet for the given time period (e.g., a week, a month, etc.). Thus, the timesheet information may include one or more time-entry records for any work that the contractor has previously performed within the given time period (e.g., the work week) and, as the contractor works additional shifts throughout the work week, may later include one or more time-entry records for the additional shifts that the contractor works during the work week.

In some embodiments, the time management platform 104 may identify and provide the user device 102 with the timesheet information of the contractor. For example, the time management platform 104 may process the request for the timesheet information (e.g., which includes the user/organization identifier and the date information) and may use information included in the request to reference a data structure that associates corresponding stored information with other timesheet information of the contractor. In this case, the time management platform 104 may identify the stored timesheet information based on determining that the information included in the request (e.g., the user/organization identifier, the date information, etc.) matches corresponding stored information (e.g., a corresponding stored user/organization identifier, corresponding stored date information, etc.). The time management platform 104 may provide the identified timesheet information to the user device 102 (e.g., using the communication interface).

In this way, the user device 102 obtains the timesheet information of the contractor. Moreover, the user device 102 obtains the timesheet information without requiring the contractor to engage in and complete a separate credentialing process. This conserves resources (e.g., processing resources, memory resources, network resources, and/or the like) that a conventional VMS would expend credentialing the contractor. For example, a conventional VMS would expend resources processing credentialing information of the contractor when the contractor showed up at the worksite for the scheduled shift, expend network resources transmitting the credentialing information to a backend server, and expend memory resources storing the credentialing information. In this conventional system, the credentialing information may, for example, be a complete user profile of the contractor (e.g., which the contractor is asked to create at the start of the shift).

As shown by reference number 122, the user device 102 may display the timesheet information of the contractor. For example, the user device 102 may display the timesheet information via the user interface of the timesheet application. This may allow the contractor to view and/or verify time-entry records for any shifts that have been previously completed within the given time period. In the example shown, the timesheet information may include a time-entry record for the shift that the contractor worked on Monday, Jul. 11, 2022.

As shown in FIG. 1D, and by reference number 124, the user device 102 may determine appropriate clock-in and clock-out display buttons. For example, the user device 102 may determine appropriate display buttons so that the clock-in button (or the clock-out button) is accentuated on the user interface to assist the contractor in selecting the appropriate display button. This reduces user error and improves the accuracy of the time-entry records.

In some embodiments, the user device 102 may determine the appropriate display buttons by predicting whether the contractor is clocking-in or clocking-out. For example, the user device 102 may predict whether the contractor is clocking-in or clocking-out based on the timesheet information of the contractor. In the example shown, the timesheet information indicates that on Monday Jul. 11, 2022, the contractor clocked-in at 8:00 am and clocked-out at 4:00 pm. Additionally, as described above, the contractor has just logged into the timesheet application at 8:00 am on Tuesday Jul. 12, 2022. Based on this information, the user device 102 may predict that the next clock interaction will be the contractor clocking-in. As will be described in detail below, the user device 102 may, based on this prediction, determine that the appropriate clock-in button to be displayed via the user interface is a clock-in button that is accentuated relative to the clock-out button.

As a preliminary matter, it will be important to understand that when the contractor clocks-in, a database configuration of the time management platform 104 may not allow the time-entry record to include a null value for the clock-out time. As such, the clock-out time is given a temporary value. In the example described herein, this value may be set to one minute. This means that when the contractor clocked-in at 8:00 am on Monday Jul. 11, 2022, a temporary value of 8:01 am was assigned as the clock-out time. This temporary value of 8:01 am was replaced with 4:00 pm when the contractor clocked-out at the end of the shift.

In some embodiments, to determine the appropriate clock-in/clock-out buttons, the user device 102 may first determine whether the last time entry made was a clock-in time entry or a clock-out time entry. In the example shown, the last time-entry was made when the contractor clocked-out at 4:00 pm on Monday, Jul. 11, 2022. Next, the user device 102 may determine whether a difference in time between the two most recent time entries is greater than a configurable time differential. In the example provided, the user device 102 may determine whether a difference in time between the clock-in time (e.g., 8:00 am) and the clock-out time (e.g., 4:00 pm) is greater than a configurable time differential. The configurable time differential may be set based on the temporary value that is used as the clock-out value. In the example above, the configurable time differential may be set to one minute (e.g., because the temporary value used as the clock-out value is set as one minute after the clock-out time). Continuing with the example, the user device 102 may determine that the difference between the clock-in time (e.g., 8:00 am) and the clock-out time (e.g., 4:00 pm) is eight hours, which is greater than the configurable time differential of one minute. This allows the user device 102 to determine that the next appropriate clock interaction will be to clock-in.

However, assume that the contractor forgot to clock-out at the end of the last shift. In this example, the clock-out value for the last shift will still be set to the temporary value of 8:01 am. As such, the user device 102 may determine that the difference between the clock-in time (e.g., 8:00 am) and the clock-out time (e.g., 8:01 am) is one minute, which is not greater than the configurable time differential of one minute.

In this situation, the user device 102 may then determine whether the clock-out time (e.g., 8:01 am) is within a threshold number of hours of a current time. As an example, the user device 102 may determine whether the clock-out time of 8:01 am is within 16 hours of a current time. If the clock-out time of 8:01 am is not within 17 hours of the current time, the user device 102 may determine that the last time entry made by the contractor was clocking-out. Thus, the user device 102 may determine that the next appropriate clock interaction would be to clock-in. If the clock-out time of 8:01 am is within 17 hours of the current time, the user device 102 may determine that the last time entry made by the contractor was clocking-in. As such, the user device 102 may determine that the next appropriate clock interaction is to clock-out.

In some embodiments, a database configuration of the time management platform 104 may permit null values to be used as the clock-out time of the time-entry record. In this case, the user device 102 may be configured to include a null value as the clock-out time. Thus, regardless of the database configuration implemented by the time management platform 104, the user device 102 will be configured such that data transmitted will be compliant with any database configuration restrictions.

As shown by reference number 126, the user device 102 may display the appropriate clock-in and/or clock-out buttons. For example, because the user device 102 has determined that the next clock interaction for the contractor is to clock-in, the user device 102 may display a clock-in button that is a first color, such as green or another color (whereas the clock-out button is orange or another color), a clock-in button that is larger than the clock-out button, and/or any other visual variation of clock-in/out buttons that suggests to the contractor that he or she should select the clock-in button to begin the shift. Additionally, or alternatively, the user device 102 may generate and display one or more other visual indicators or cues that direct the contractor to select the appropriate clock-in or clock-out buttons.

As shown by reference number 128, the contractor may interact with the clock-in button to begin the shift. In the example shown, the user interface of the timesheet application displays the clock-in and clock-out buttons, where the clock-in button is larger than the clock-out button and where the clock-in button is the first color (e.g., green), and the clock-out button is the second color (e.g., orange). In this example, the contractor may interact with (e.g., select, click on, etc.) the clock-in button to start the shift.

In some embodiments, the user device 102 may have accentuated the incorrect clock-in or clock-out button. For example, assume the contractor worked a double, where the first shift was 8:00 am to 4:00 μm and the second shift was 12:00 am to 8:00 am. In this example, if the contractor goes to clock-out at 8:00 am, but had forgotten to clock-in at 12:00 am, the user device 102 might mistakenly suggest that the contractor should clock-in. In this case, when the contractor goes to clock-out at 8:00 am, the contractor may still click on the clock-out button, even though clock-in button has been accentuated. This may cause the user device 102 to generate and provide the time management platform 104 with an exception message. The exception message can be made available to a manager (e.g., using the manager device 106) to alert the manager of the issue. The manager can then interact with the timesheet application to correct the time entry error or may reach out to the contractor to ensure that the time entry error is corrected.

In some embodiments, the user device 102 may receive an indication that the contractor has started the shift using one or more other means. For example, the user device 102 may (e.g., using the timesheet application) have a voice recognition feature that allows the contractor to perform timesheet requests verbally. To provide a specific example, the contractor may issue a verbal command (e.g., “please start my shift”) which may cause the user device 102 to verify the contractor's voice and begin the shift (e.g., by generating a clock-in value equal to a current time). In some embodiments, one or more other aspects of the timesheet application may be implemented using voice recognition, retinal scanning, and/or the like. For example, rather than inputting the user identifier (e.g., the 8-digit code) at the start of the shift, the contractor may be able to issue a verbal command, receive retinal scan verification, and/or the like.

In this way, the user device 102 predicts whether the contractor is clocking-in or clocking-out and tailors the clock-in/out buttons to improve the likelihood that the contractor selects the appropriate button. This reduces time entry reporting errors, thereby conserving resources (e.g., processing resources, network resources, memory resources, and/or the like) that might otherwise be expended to generate, transmit, and/or store incorrect time-entry records. This further conserves resources that would be expended executing an error correction procedure needed to correct the time entry error. Still further, by generating and transmitting an exception message when the contractor does not select what the user device 102 determines to be the appropriate next clock interaction, a manager is notified and can act to resolve any resulting time entry issues. In some embodiments, functionality allowing the manager to be notified may be handled by the time management platform 104.

As shown in FIG. 1E, and by reference number 130, the user device 102 may generate a first time-entry record for the shift. For example, the user device 102 may, based on the contractor starting the shift, generate timesheet information that includes a first time-entry record for the shift.

The first time-entry record for the shift may include a user/organization identifier, date information indicating a current date, time information including information indicating a clock-in time and/or information indicating a clock-out time, and/or the like. In some embodiments, a zero value or null value may not be an acceptable input to provide as a clock-out time value. Since the contractor has yet to input a clock-out time, the user device 102 may generate a placeholder clock-out time value. To provide a specific example, the user device 102 may generate, as the first time-entry of the shift, a clock-in time value that matches a time in which the contractor clocked-in, and a placeholder clock-out time value of one minute after the time at which the contractor clocked-in.

In some embodiments, the user device 102 may generate the timesheet information using an internal clock that is synchronized with a clock of the time management platform 104. In some embodiments, the user device 102 may generate the timesheet information by requesting a current time value from the time management platform 104.

In some embodiments, the user device 102 may append the first time-entry record to the existing time-entry records included in the timesheet information. For example, if the contractor had worked one or more shifts earlier in the week, the timesheet information may include a list of all prior time-entry records corresponding to the contractor for the given time period. In this case, the user device 102 may append the first time-entry record to the list of prior time-entry records included in the timesheet information. In the example shown, the user device 102 may generate a first time-entry record that includes a user/organization identifier (e.g., C0000018), a date (e.g., 07-12-2022), a clock-in time (e.g., 08:00:01), and a clock-out time (e.g., 08:01:01). As described above, because the clock-out time field cannot contain a null value, the clock-out time is set to a temporary value equal to one minute after the clock-in time value.

In some embodiments, the user device 102 may generate corrected timesheet information. For example, if the contractor forgot to clock-out at the end of the prior shift, the contractor may be prompted to input corrected timesheet information that indicates the correct clock-out time for the prior shift. This may cause the user device 102 to generate corrected timesheet information that includes the correct clock-out time for the prior shift. In some embodiments, the user device 102 may generate flagged timesheet information. For example, if the contractor forgot to clock-out at the end of the prior shift, the user device 102 may generate flagged timesheet information and may provide the flagged timesheet information to the manager device 106. This may allow a manager to review the flagged timesheet information and to approve an appropriate corrected time-entry record.

As shown by reference number 132, the user device 102 may provide, to the time management platform 104, the timesheet information that includes the first time-entry record of the shift. The timesheet information may include the first time-entry record of the shift and any other time-entry records generated within the given time period (e.g., within the current work week).

In some situations, the worksite may have multiple user devices 102 available for clocking in and out. In these situations, any of the user devices 102 may be used to allow a contractor to clock-in and any of these user devices 102 may be used to allow that same contractor to clock-out. However, assume a network connection between the user devices 102 and the time management platform 104 falters. Further assume that while the network connection is down that a contractor utilizes a first user device 102 to clock-in and a second user device 102 to clock-out. In this case, when the contractor clocks-out, the second user device 102 has no knowledge that the contractor had previously clocked-in with the first user device 102.

Continuing with the example, when the network connection is restored, each user device 102 may provide a respective time-entry record to a first custom server application. The first custom server application may support a database that is separate from the time management platform 104 and that can store the time-entry records received from each user device 102. Next, a manager may access a second custom server application to sort and/or organize the timesheet information received during the time period in which the network connection was down. For example, a manager device 106 may support access to a second custom server application. In this case, the manager may interact with a user interface of the manager device 106 to request, from the second custom server application, time-entry records for a given time period (e.g., a time period during which the network was down, a work week, etc.).

Continuing with the example, the second custom server application may obtain, from the first custom server application (and/or from time management platform 104), the time-entry records corresponding to the given time period. The second custom server application may then combine or aggregate the time-entry records received from the first custom server application with any time-entry records received from the time management platform 104 and may present the combined or aggregated time-entry records for display on the user interface of the manager device 106. The manager may be able to approve or correct the time-entry records such that approved or corrected timesheet information is stored by the time management platform 104.

In some embodiments, generation of the corrected timesheet information may be automated and performed by the second custom server application and/or by the time management platform 104. In some embodiments, a single custom server application may be utilized. For example, the same custom server application may be used to obtain time-entry records from the user devices 102 and/or from the time management platform 104, to store time-entry records, to provide combined and/or aggregated time-entry records for display on a user interface of the manager device 106, and/or the like.

In this way, accurate timekeeping records may be maintained, even in situations where a network connection falters.

As shown by reference number 134, the time management platform 104 may store the timesheet information that includes the first time-entry record of the shift. For example, the time management platform 104 may store the timesheet information such that the timesheet information replaces previously stored timesheet information of the contractor. To provide a specific example, the time management platform 104 may process the received timesheet information to identify the user/organization identifier (e.g., which is a field within the received timesheet information). The time management platform 104 may then locate stored timesheet information of the contractor (e.g., which may be stored in association with a corresponding user/organization identifier) and may replace the stored timesheet information with the timesheet information that includes the first time-entry record of the shift.

In this way, the user device 102 generates and provides the timesheet information to the time management platform 104 such that the stored timesheet information is overwritten using the timesheet information that includes the first time-entry record.

In some embodiments, the user device 102 may be configured to provide the time management platform 104 with a ping message. For example, the user device 102 may be configured to periodically ping (e.g., every minute, every several minutes, etc.) the time management platform 104. The ping message may include a user/organization identifier, an organization identifier, a worksite identifier, a device identifier (e.g., a GUID), application version information, application launch date information, current date information, and/or the like. In some embodiments, the ping message may be used to maintain a connection between the user device 102 and the time management platform 104. In some embodiments, ping messages received from multiple user devices 102 may provide an indication as to whether a network connection at the worksite is up or down. For example, if the network connection at the worksite falters, the user devices 102 may be unable to continue periodically sending ping messages to the time management platform 104. This may, for example, alert a manager that the worksite is having network connectivity problems.

In some embodiments, the time management platform 104 may provide a shift status report for display on a user interface of the manager device 106. For example, the time management platform 104 may process timesheet information for a shift and may generate a shift status report that may be provided for display on a virtual dashboard accessible to a manager. This may, for example, allow the manager to view the dashboard to see that the contractor has clocked-in to begin the shift and to see that the contractor has yet to clock-out to end the shift.

As shown in FIG. 1F, and by reference number 136, the contractor may interact with the user device 102 to input the user identifier. For example, the shift of the contractor may have ended, and the contractor may interact with a user interface of the timesheet application to input the user identifier. This may provide the contractor with access to the timesheet to allow the contractor to clock-out to end the shift. In the example shown, the contractor may input “02155906” as the 8-digit code at a time of 4:03:55 pm.

As shown by reference number 138, the user device 102 may verify the user identifier. For example, the user device 102 may verify the user identifier by comparing the user identifier input by the contractor with the set of user identifiers for the group of contractors that are scheduled to work at the worksite for the given time period. The user device 102 may verify the user identifier based on determining that the user identifier input by the contractor matches a corresponding user identifier that is stored in association with the contractor's profile information.

As shown by reference number 140, the user device 102 may display the profile information and/or the timesheet information of the contractor. For example, the user device 102 may display the profile information of the contractor based on verifying the user identifier. Additionally, because the user device 102 is the same device that the contractor used to clock-in at the start of the shift, the user device 102 may already have access to the timesheet information that includes the first time-entry record of the contractor. In this case, the user device 102 may also display the timesheet information that includes the first time-entry record of the contractor. In the example shown, the timesheet information displayed may include the time-entry record for the shift that the contractor worked on Monday Jul. 11, 2022, and may include the clock-in time (8:00 am) for the current shift that the contractor is working (e.g., Tuesday Jul. 12, 2022). As described above, the clock-out time may be set to a temporary value of 8:01 am (e.g., one minute after the clock-in time). However, in some embodiments, such as the example shown, the temporary clock-out value may be omitted from being displayed on the user interface.

In some embodiments, the contractor may clock-in using a first user device 102 and may clock-out using a second user device 102. For example, the contractor may interact with an interface of the timesheet application (e.g., on the second user device 102), which may cause the second user device 102 to verify the user identifier and to display the profile information of the contractor. In this case, because the timesheet information of the contractor is not stored locally on the second user device 102, the second user device 102 may obtain the timesheet information of the contractor from the time management platform 104. The timesheet information may then be displayed on the interface of the timesheet application. Furthermore, the second user device 102 may verify the received timesheet information (e.g., in a manner consistent with that described in connection with reference number 126). In this way, a stateless design is provided that enables the contractor to clock-in and clock-out irrespective of which user device 102 is being used. This improves flexibility, reduces a utilization of resources of a singular user device 102 (e.g., as the processing workload may be distributed between multiple devices), and improves accuracy of timekeeping in the event that a particular user device 102 malfunctions.

As shown in FIG. 1G, and by reference number 142, the user device 102 may determine appropriate clock-in and clock-out display buttons. For example, the user device 102 may determine appropriate display buttons so that the clock-out button (or the clock-in button) is accentuated on the user interface to assist the contractor in selecting the appropriate display button. This reduces user error and improves the accuracy of the time-entry records.

In some embodiments, the user device 102 may determine the appropriate display buttons by predicting whether the contractor is clocking-in or clocking-out. For example, the user device 102 may predict whether the contractor is clocking-in or clocking-out based on the timesheet information of the contractor. In the example shown, the timesheet information indicates that on Monday Jul. 11, 2022, the contractor clocked-in at roughly 8:00 am and clocked-out at roughly 4:00 pm. Further, the contractor has clocked-in on Tuesday Jul. 12, 2022, at 8:00 am. Additionally, the contractor has just logged into the timesheet application at roughly 4:03 pm on Tuesday Jul. 12, 2022. Based on this information, the user device 102 may predict that the next clock-in/clock-out action will be the contractor clocking-out. As will be described in detail below, the user device 102 may, based on this prediction, determine that the appropriate clock-out button to be displayed via the user interface is a clock-out button that is accentuated relative to the clock-in button.

In some embodiments, to determine the appropriate clock-in/clock-out buttons, the user device 102 may first determine whether the last time entry made was a clock-in time entry or a clock-out time entry. In the example shown, the last time-entry record was the contractor clocking-in for the current shift on Tuesday Jul. 12, 2022. The user device 102 may determine whether a difference between the clock-in time (e.g., 8:00 am) and the clock-out time (e.g., the temporary clock-out time value of 8:01 am) is greater than a configurable time differential (e.g., one minute). As described in connection with FIG. 1D, the configurable time differential may be set based on the temporary value that is used as the clock-out value. In the example above, the configurable time differential may be set to one minute (e.g., because the temporary value used as the clock-out value is set as one minute after the clock-out time). Continuing with the example, the user device 102 may determine that the difference between the clock-in time (e.g., 8:00 am) and the clock-out time (e.g., 8:01 am) is one minute, which is not greater than the configurable time differential of one minute.

Next, the user device 102 may determine whether the clock-out time (e.g., 8:01 am) is within a threshold number of hours of a current time. In the example shown, the user device 102 may determine whether a clock-out time of 8:01 am is within 16 hours of the current time. Because the clock-out time of 8:01 am is within 16 hours of the current time, the user device 102 may determine that the last time entry record made by the contractor was clocking-in and that the next appropriate clock interaction is to clock-out.

As shown by reference number 144, the user device 102 may display the appropriate clock-in and/or clock-out buttons. For example, because the user device 102 has determined that the next clock interaction for the contractor is to clock-out, the user device 102 may display a clock-out button that is green (whereas the clock-in button is orange), a clock-out button that is larger than the clock-in button, and/or any other visual variation of clock-in/out buttons that suggests to the contractor that he or she should select the clock-out button to begin the shift. Additionally, or alternatively, the user device 102 may generate and display one or more other visual indicators or cues that direct the contractor to select the appropriate clock-in or clock-out buttons.

As shown by reference number 146, the contractor may interact with the clock-out button to end the shift. In the example shown, the user interface of the timesheet application displays the clock-in and clock-out buttons, where the clock-out button is larger than the clock-in button, and where the clock-out button is green and the clock-in button is orange. In this example, the contractor may interact with (e.g., select, click on, etc.) the clock-out button to end the shift.

As shown in FIG. 1H, and by reference number 148, the user device 102 may generate a second time-entry record for the shift. For example, the user device 102 may, based on the contractor clocking-out to end the shift, generate a second time-entry record for the shift. The second time-entry record may include a user/organization identifier, date information indicating a current date, a clock-in time value, a clock-out time value, and/or the like. The clock-in time value may be a value that corresponds to a time at which the contractor started the shift. The clock-out time value may be a value that corresponds to a current time at which the contractor is clocking out to end the shift. The timesheet information may include all time-entry records for the given time period, including time-entry records for prior shifts worked within the given time period, the first time-entry record, and the second time-entry record.

In some embodiments, the user device 102 may append the second time-entry record to the existing time-entry records included in the timesheet information. In some embodiments, the second time-entry record may replace the first time-entry record. In some embodiments, the second time-entry record may be appended below the existing time-entry records (e.g., below the first time-entry record and any other preceding time-entry records). In the example shown, the user device 102 may generate a second time-entry record that includes a user/organization identifier (e.g., C0000018), a date (e.g., 07-12-2022), a clock-in time (e.g., 08:00:01), and a clock-out time (e.g., 04:03:58).

As shown by reference number 150, the user device 102 may provide the timesheet information that includes the second time-entry record to the time management platform 104. The timesheet information may include the second time-entry record, which has replaced the first time-entry record, and any other time-entry records generated within the given time period.

As shown by reference number 152, the time management platform 104 may store the timesheet information that includes the second time-entry record. For example, the time management platform 104 may store the timesheet information such that the timesheet information replaces the previously stored timesheet information of the contractor. To provide a specific example, the time management platform 104 may process the updated timesheet information to identify the user/organization identifier (e.g., which is a field within the timesheet information received from the user device 102). The time management platform 104 may then locate stored timesheet information of the contractor (e.g., which may be stored in association with a corresponding matching user/organization identifier) and may replace the stored timesheet information with the timesheet information received from the user device 102.

In this way, the user device 102 generates and provides the timesheet information to the time management platform 104 such that the stored timesheet information is overwritten using the timesheet information that includes the second time-entry record.

As shown in FIG. 1I, and by reference number 154, a manager may interact with a user interface of the manager device 106 to modify a schedule of the contractor. For example, a manager may have access to the timesheet application, which may display timesheet information for the group of contractors scheduled to work at the worksite. The manager may interact with a user interface of the timesheet application to modify the schedule of the contractor. The manager may modify the schedule of the contractor by adding an additional shift to the schedule, removing a previously scheduled shift, modifying a start time of a scheduled shift, modifying an end time of a scheduled shift, and/or the like.

As shown by reference number 156, the manager device 106 may provide, to the time management platform 104, timesheet information that includes a time-entry record indicating a modification to the schedule of the contractor. For example, the manager device 106 may generate timesheet information that includes a time-entry record indicating the modification to the schedule of the contractor. Next, the manager device 106 may, using the communication interface, provide the time management platform 104 with the timesheet information that includes the time-entry record indicating the modification to the schedule of the contractor. The timesheet information may include time-entry records for any previous shifts that the contractor worked during the given time period (e.g., the current work week), the first and second time-entry records for the contractor's shift as described above, and the time-entry record indicating the modification to the schedule of the contractor.

As shown by reference number 158, the time management platform 104 may store the timesheet information that includes the time-entry record indicating the modification to the schedule of the contractor. For example, the time management platform 104 may store the timesheet information such that the timesheet information replaces previously stored timesheet information of the contractor.

As shown by reference number 160, the time management platform 104 may provide the timesheet information to the user device 102. For example, the time management platform 104 may provide the user device 102 with the timesheet information via the communication interface.

In some embodiments, the time management platform 104 may be configured to provide the timesheet information to the user device 102 automatically. For example, the time management platform 104 may be configured such that any time there is a modification to the schedule of the contractor, timesheet information reflecting the modification is provided to the user device 102 (and/or to any other authorized devices and/or accounts).

In some embodiments, the time management platform 104 may provide the timesheet information to the user device based on a request from the manager device 106. For example, the manager may interact with the interface of the timesheet application (displayed on manager device 106) to input the modification to the schedule of the contractor and may further interact with the interface to request that the modification be forwarded the user device 102. In some embodiments, the timesheet information may be provided an account associated with the contractor, an email address associated with the contractor, and/or the like.

In this way, the manager device 106 provides timesheet information (e.g., with the modification to the schedule) to the time management platform 104, such that the stored timesheet information is over-written using the timesheet information generated by the manager device 106. Furthermore, by providing the timesheet information with the modification to the schedule to the user device 102, real-time changes in the VMS are reflected in and made available to the contractor via the user interface of the timesheet application.

As indicated above, FIGS. 1A-1I are provided merely as an example. Other examples may differ from what is described with regard to FIGS. 1A-1I. For example, there may be additional devices and/or networks, fewer devices and/or networks, different devices and/or networks, or differently arranged devices and/or networks than those shown in FIGS. 1A-1I. Furthermore, two or more devices shown in FIGS. 1A-1I may be implemented within a single device, or a single device shown in FIGS. 1A-1I may be implemented as multiple and/or distributed devices. Additionally, or alternatively, a set of devices (e.g., one or more devices) of example embodiment(s) 100 may perform one or more functions described as being performed by another set of devices of example embodiment(s) 100.

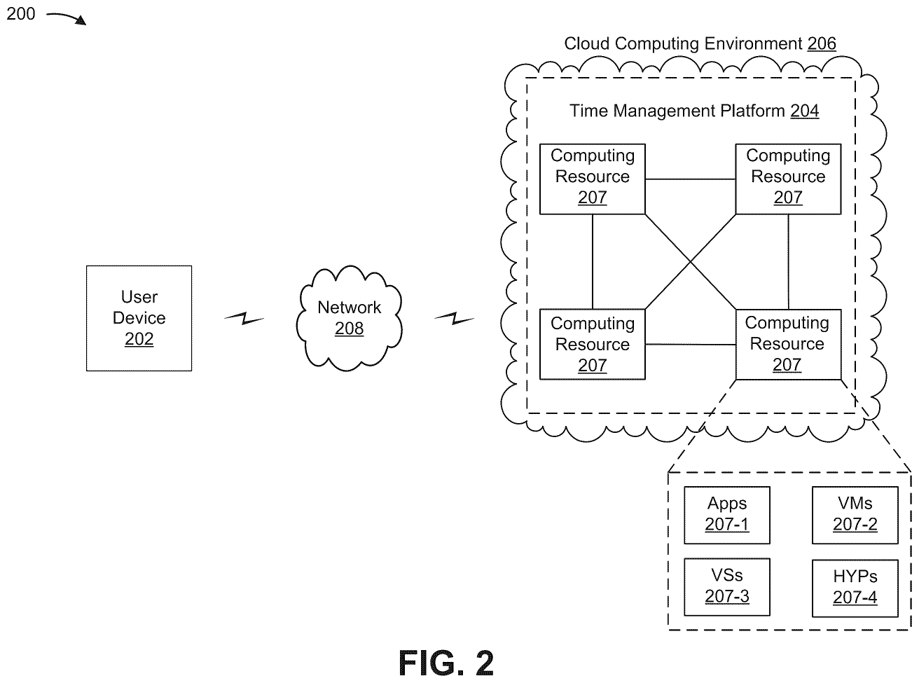

FIG. 2 is a diagram of an example environment 200 in which systems and/or methods described herein may be implemented. As shown in FIG. 2, environment 200 may include a user device 202, a time management platform 204 supported within a cloud computing environment 206, and/or a network 208. Devices of environment 200 may interconnect via wired connections, wireless connections, or a combination of wired and wireless connections.

User device 202 includes one or more devices capable of receiving, generating, storing, processing, and/or providing information associated with a timesheet application. For example, user device 202 may include a device, such as a tablet computer (e.g., an iPad, etc.), a mobile phone (e.g., a smart phone, a radiotelephone, etc.), a laptop computer, a handheld computer, a server computer, a gaming device, a wearable communication device (e.g., a smart wristwatch, a pair of smart eyeglasses, etc.), or a similar type of device. In some embodiments, the user device 202 may have an internal clock for keeping track of time. In some embodiments, the internal clock of the user device 202 may be synchronized with an internal clock of the time management platform 204.

In some embodiments, the user device 202 may communicate with the time management platform 204 using a communication interface (e.g., using the network 208). In some embodiments, the user device 202 may not have access to an application programming interface (API) when communicating with the time management platform 204. In this case, the user device 202 may communicate with the time management platform 204 by making read requests and write requests, such that the read requests obtain a copy of the information stored by the time management platform 204, and such that the write requests over-write stored information with new information being provided by the user device 202. In some embodiments, the user device 202 may use a mapping feature (e.g., such as object-relational mapping (ORM)) when querying a data structure associated with the time management platform 204.

In some embodiments, the user device 202 may communicate with the time management platform 204 using a communication interface that was designed for a different purpose. For example, the communication interface may have been designed to let business managers (e.g., not independent contractors) download documents that can be used to assist in managing their business. In this example, the communication interface is not designed for seamless real-time transmission of time information between the user device 202 and the time management platform 204. Regardless, the user device 202 may be configured to seamlessly transmit information to, and receive information from, the time management platform 204 in real-time.

While one or more embodiments described herein may refer to communications between devices as being made without the use of an API, it is to be understood that this is provided by way of example. In practice, an API could be implemented to assist with communications between one or more of the described devices.

In some embodiments, the user device 202 may obtain, from the time management platform 204, profile information and/or timesheet information of one or more contractors. For example, the user device 202 may provide, to the time management platform 204, a request for the profile information for the one or more contractors. This may cause the time management platform 204 to provide the profile information to the user device 202. As another example, the user device 202 may provide, to the time management platform 204, a request for the timesheet information of a contractor. This may cause the time management platform 204 to provide the user device 202 with the timesheet information of the contractor.

In some embodiments, the user device 202 may provide a ping message to the time management platform 204. For example, the user device 202 may be configured to provide the time management platform 204 with a ping message to maintain a data session between the two devices. The user device 202 may provide the time management platform 204 with the ping message at scheduled intervals (e.g., every minute, every several minutes, every hour, etc.). The ping message may include an organization identifier, a worksite identifier, a device identifier (e.g., a GUID), an application version identifier, date and time information indicating a date and time at which the timesheet application was launched, date and time information indicating a current date and time, and/or the like.

In some embodiments, the user device 202 must be registered to access the timesheet application. In this case, the user device 202 may be assigned the device identifier (e.g., the GUID) during the registration process. By registering the user device 202, security is improved by restricting access to registered devices.

In some embodiments, a first user device 202 may be a device that a contractor uses to access a timesheet. In some embodiments, a second user device 202 (e.g., a manager device) may be a device that a manager uses to access timesheets for a group of contractors. In some embodiments, a group of user devices 202 may be located at a worksite and used to provide timesheet services to contractors scheduled to work at the worksite. In some embodiments, a user device 202 may be assigned to a specific contractor. In some embodiments, a user device 202 may be assigned to multiple contractors.

Time management platform 204 includes one or more devices capable of receiving, storing, processing, and/or providing information associated with the timesheet application. For example, time management platform 204 may include a server device (e.g., a host server, a web server, an application server, etc.), a data center device, or a similar device. In some embodiments, the time management platform 204 may have an internal clock for keeping track of time. In some embodiments, the time management platform 204 may communicate with the user device 202 via the communication interface.

In some embodiments, the time management platform 204 may be a vendor management system (VMS). In some embodiments, the time management platform 204 may be a third-party server that interfaces between a VMS and vendor devices. In some embodiments, the time management platform 204 may be another type of procurement management system, such as a contract service management (CSM) system, an enterprise management (EM) system, and enterprise resource planning (ERP) system, and/or the like.

In some embodiments, the time management platform 204 may store information associated with a timesheet application. In some embodiments, the information associated with the timesheet application may be stored using a third-party server, such that the information is accessible to the time management platform 204 (and/or accessible to the user device 202).

In some embodiments, as shown, the time management platform 204 may be hosted in the cloud computing environment 206. Notably, while embodiments described herein describe the time management platform 204 as being hosted in the cloud computing environment 206, in some embodiments, the time management platform 204 may not be cloud-based (i.e., may be implemented outside of a cloud computing environment) or may be partially cloud-based.

Cloud computing environment 206 includes an environment that hosts time management platform 204. Cloud computing environment 206 may provide computation, software, data access, storage, etc. services that do not require end-user knowledge of a physical location and configuration of system(s) and/or device(s) that hosts the time management platform 204. As shown, the cloud computing environment 206 may include a group of computing resources 207 (referred to collectively as “computing resources 207” and individually as “computing resource 207”).

Computing resource 207 includes one or more personal computers, workstation computers, server devices, or another type of computation and/or communication device. In some embodiments, the computing resource 207 may host the time management platform 204. The cloud resources may include compute instances executing in the computing resource 207, storage devices provided in the computing resource 207, data transfer devices provided by the computing resource 207, and/or the like. In some embodiments, the computing resource 207 may communicate with other computing resources 207 via wired connections, wireless connections, or a combination of wired and wireless connections.

As further shown in FIG. 2, computing resource 207 may include a group of cloud resources, such as one or more applications (“APPs”) 207-1, one or more virtual machines (“VMs”) 207-2, virtualized storage (“VSs”) 207-3, one or more hypervisors (“HYPs”) 207-4, and/or the like.

Application 207-1 may include one or more software applications that may be provided to or accessed by user device 202. Application 207-1 may eliminate a need to install and execute the software applications on these devices. In some embodiments, one application 207-1 may send/receive information to/from one or more other applications 235-1, via virtual machine 207-2. In some embodiments, application 207-1 may be a timesheet application. In some embodiments, application 207-1 may be a procurement management application that includes one or more timesheet modules. In some embodiments, the timesheet application may support a virtual clock or other means of keeping track of time. In some embodiments, the timesheet application may include one or more user interfaces that are accessible by users such as contractors. In some embodiments, the timesheet application may include one or more user interfaces that are accessible by users such as managers.

Virtual machine 207-2 may include a software implementation of a machine (e.g., a computer) that executes programs like a physical machine. Virtual machine 207-2 may be either a system virtual machine or a process virtual machine, depending upon use and degree of correspondence to any real machine by virtual machine 207-2. A system virtual machine may provide a complete system platform that supports execution of a complete operating system (“OS”). A process virtual machine may execute a single program and may support a single process. In some embodiments, virtual machine 207-2 may execute on behalf of another device (e.g., user device 202), and may manage infrastructure of the cloud computing environment 206, such as data management, synchronization, or long-duration data transfers.

Virtualized storage 207-3 may include one or more storage systems and/or one or more devices that use virtualization techniques within the storage systems or devices of the computing resource 207. In some embodiments, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 207-4 may provide hardware virtualization techniques that allow multiple operating systems (e.g., “guest operating systems”) to execute concurrently on a host computer, such as computing resource 207. Hypervisor 207-4 may present a virtual operating platform to the guest operating systems and may manage the execution of the guest operating systems.

Network 208 includes one or more wired and/or wireless networks. For example, network 208 may include a cellular network (e.g., a fifth generation (5G) network, a fourth generation (4G) network, such as a long-term evolution (LTE) network, a third generation (3G) network, a code division multiple access (CDMA) network, a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

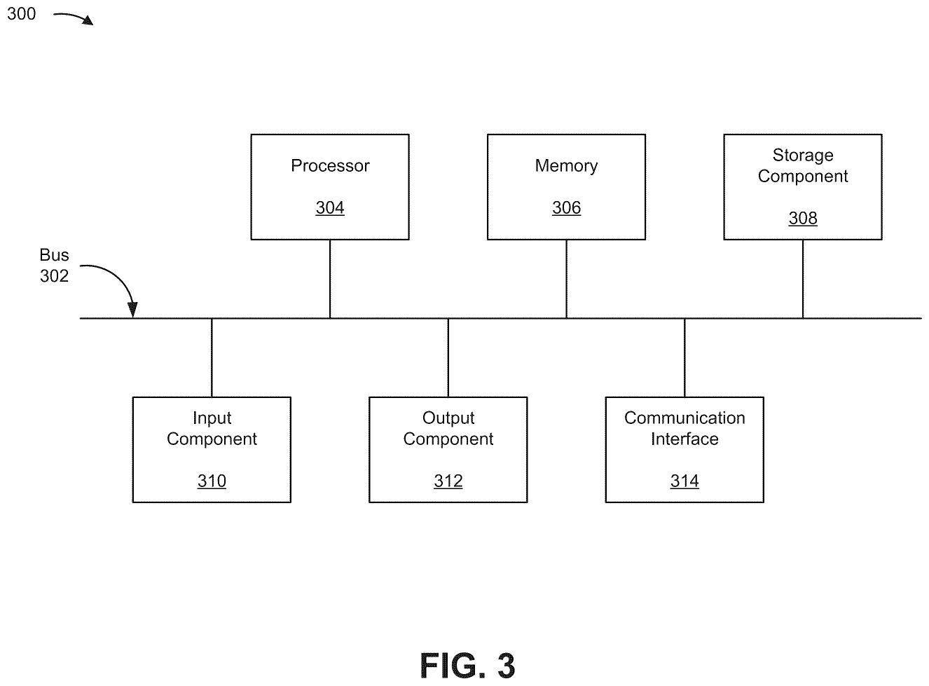

FIG. 3 is a diagram of example components of a device 300. Device 300 may correspond to the user device 202 and/or the time management platform 204. In some embodiments, the user device 202 and/or the time management platform 204 may include one or more devices 300 and/or one or more components of device 300. As shown in FIG. 3, device 300 may include a bus 302, a processor 304, a memory 306, a storage component 308, an input component 310, an output component 312, and/or a communication interface 314.

Bus 302 includes a component that permits communication among multiple components of device 300. Processor 304 is implemented in hardware, firmware, and/or a combination of hardware and software. Processor 304 includes a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and/or another type of processing component. In some embodiments, processor 304 includes one or more processors capable of being programmed to perform a function. Memory 306 includes a random-access memory (RAM), a read only memory (ROM), and/or another type of dynamic or static storage device (e.g., a flash memory, a magnetic memory, and/or an optical memory) that stores information and/or instructions for use by processor 304.

Storage component 308 stores information and/or software related to the operation and use of device 300. For example, storage component 308 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 310 includes a component that permits device 300 to receive information, such as via user input (e.g., a touch screen display, a keyboard, a keypad, a mouse, a button, a switch, and/or a microphone). Additionally, or alternatively, input component 310 may include a sensor for sensing information (e.g., a global positioning system (GPS) component, an accelerometer, a gyroscope, and/or an actuator). Output component 312 includes a component that provides output information from device 300 (e.g., a display, a speaker, and/or one or more light-emitting diodes (LEDs)).

Communication interface 314 includes a transceiver-like component (e.g., a transceiver and/or a separate receiver and transmitter) that enables device 300 to communicate with other devices, such as via a wired connection, a wireless connection, or a combination of wired and wireless connections. Communication interface 314 may permit device 300 to receive information from another device and/or provide information to another device. For example, communication interface 314 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes based on processor 304 executing software instructions stored by a non-transitory computer-readable medium, such as memory 306 and/or storage component 308. A computer-readable medium is defined herein as a non-transitory memory device. A memory device includes memory space within a single physical storage device or memory space spread across multiple physical storage devices.

Software instructions may be read into memory 306 and/or storage component 308 from another computer-readable medium or from another device via communication interface 314. When executed, software instructions stored in memory 306 and/or storage component 308 may cause processor 304 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

In summary, traditional VMS's inefficiently and/or ineffectively utilize resources (e.g., processing resources, network resources, memory resources, etc.) when performing tasks relating to timekeeping. For example, when electronic credentials are used, each time a new contingent laborer visits a worksite, a traditional VMS expends processing resources to create credentials for the contingent laborer, expends network resources to transmit the credentials to a backend server, and expends storage resources to store the credentials. This credentialing process must be repeated each time a new contingent laborer visits the worksite. Moreover, the contingent laborer may have issues with obtaining their credentials, may forget their credentials, and/or may lose their credentials. This problem is heightened in situations where an organization has to frequently hire new contingent laborers and/or has to hire large quantities of contingent laborers. For example, an organization may have a need to hire hundreds, possibly thousands, of contingent laborers, who will work at any of several hundred possible worksites. Because of high turnover associated with contingent laborers, traditional VMS's needlessly expend resources by continually credentialing new contingent laborers.

Furthermore, traditional VMS's utilize resources inefficiently and/or ineffectively when performing timekeeping-related tasks. For example, contingent laborers are often working at worksites for the first time and are often unfamiliar with the timekeeping procedures of the organization that has contracted them to perform a job or task. Consequently, contingent laborers are more likely to make a timekeeping error when accessing and using an unfamiliar timekeeping interface and are more likely to forget to clock-in and/or clock-out. These mistakes lead to timekeeping recording errors, which cause a traditional VMS to expend resources processing and/or storing inaccurate timekeeping data, expend resources performing one or more error-identification functions, expend resources performing one or more error-correction functions, and/or the like. Additionally, each time a contingent laborer forgets a username and/or password, a traditional VMS must expend resources to assist in a username recovery or password reset procedure. In this case, the traditional VMS expends processing resources to process the username recovery or password reset request and expends network resources as data is transmitted between devices over a network.

Some embodiments described herein include a user device that communicates with a time management platform to provide seamless real-time timekeeping services to users such as contractors. For example, the user device may support a timesheet application that provides a user with a user identifier (e.g., a single login credential) that may be used to access the timesheet application. The user may be a contingent laborer, such as a contractor, a consultant, and/or the like. The user identifier may, for example, be a code that is known to the user, such as a 4-digit code, an 8-digit code, a 12-digit code, and/or the like. To provide a specific example, the user identifier may be an 8-digit code where the first two digits are a birth month of a contractor, the next two digits are a birth day of the contractor, and the final four digits are the last four digits of a social security number of the contractor. In this way, the user identifier is not assigned, but rather is a value already known to the contractor.

In some embodiments, the user device may verify the user identifier. After verifying the user identifier, the user device may obtain timesheet information of the contractor from the time management platform. The timesheet information may, for example, include time-entry records of one or more shifts that the contractor worked earlier in a given time period (e.g., in a given work week). Next, the user device may determine appropriate clock-in and clock-out buttons to provide for display on the user interface of the timesheet application. For example, the user device may predict whether the contractor is clocking-in or clocking-out based on the contractor's timesheet information. This may allow the user device to display the clock-in button in a way that is accentuated relative to the clock-out button.

Next, the contractor may select the clock-in button on the interface of the timesheet application. This may cause the user device to generate a time-entry record with a time-entry value indicating the time at which the contractor clocked-in. The user device may provide the timesheet information to the time management platform, such that the timesheet information replaces any previously stored timesheet information of the contractor.

At the end of the shift, the contractor may again input the single login credential, causing the user device to verify the user identifier and to display the profile information and/or timesheet information of the contractor. Next, the user device may determine the appropriate clock-in and clock-out buttons. In this case, the user device may predict that the next clock interaction of the contractor is to clock-out. As such, the user device may display a clock-out button that is accentuated relative to the clock-in button. The contractor may select a clock-out button on the interface of the timesheet application. This may cause the user device to generate a time-entry record with a time-entry value indicating the time at which the contractor clocked-out. The user device may provide the timesheet information to the time management platform, such that the timesheet information replaces any previously stored timesheet information of the contractor. The contractor may clock-in and clock-out using the same user device or by using different user devices.

In this way, the user device efficiently and effectively manages the timekeeping of the contractor. For example, the user device allows the contractor to access the timesheet application using the user identifier, without requiring the contractor to complete a worksite-specific or organization-specific credentialing process. This conserves resources (e.g., processing resources, network resources, memory resources, and/or the like) that might otherwise be expended by a conventional VMS that requires the contractor to complete a worksite-specific or organization-specific credentialing process (e.g., such as creating a user profile upon visiting the worksite). Furthermore, by configuring the user device to transmit/receive timesheet information each time a change is made to the contractor's timesheet, the user device is seamlessly integrated with the time management platform that is used to store the timesheet information, allowing a change or modification to the timesheet information to be made available in real-time or near real-time on both devices.

Moreover, several different stages of the process described herein are automated, which may remove human subjectivity and waste from the process, and which may improve speed and efficiency of the process and conserve computing resources (e.g., process resources, memory resources, and/or the like). For example, when the contractor inputs the user identifier (e.g., an 8-digit code), the contractor need only to finish inputting the user identifier (e.g., without hitting enter), causing the user device to automatically process the user identifier. To provide another example, the contractor only has to select a clock-in button to begin a shift, and only has to select a clock-out button to end the shift, causing the user device to automatically generate timesheet information based on the contractor's selection. To provide another example, messages displayed via an interface of the timesheet application are displayed for a configured time period before being automatically dismissed. These are to be understood as being provided by way of example. In practice, one or more other actions/features of the process described herein may be automated or partially automated.

The foregoing disclosure provides illustration and description but is not intended to be exhaustive or to limit the embodiments to the precise form disclosed. Modifications and variations may be made in light of the above disclosure or may be acquired from practice of the embodiments.

As used herein, the term “component” is intended to be broadly construed as hardware, firmware, and/or a combination of hardware and software.

Some embodiments are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc., depending on the context.

Certain user interfaces have been described herein and/or shown in the figures. A user interface may include a graphical user interface, a non-graphical user interface, a text-based user interface, etc. A user interface may provide information for display. In some embodiments, a user may interact with the information, such as by providing input via an input component of a device that provides the user interface for display. In some embodiments, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, and/or a combination of hardware and software. The actual specialized control hardware or software code used to implement these systems and/or methods is not limiting of the embodiments. Thus, the operation and behavior of the systems and/or methods were described herein without reference to specific software code —it being understood that software and hardware can be used to implement the systems and/or methods based on the description herein.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method for managing timesheet information of a contingent laborer, comprising:
receiving, by a user device, a request to access a timesheet application, the request including a user identifier of the contingent laborer;
verifying, by the user device, the user identifier of the contingent laborer;
obtaining, by the user device, timesheet information of the contingent laborer from an application server, the timesheet information including one or more time-entry records for one or more shifts that the contingent laborer has worked in a given time period;
providing the timesheet information of the contingent laborer for display on a user interface of the user device;
predicting, by the user device, whether the contingent laborer is clocking-in or clocking-out based at least in part on the timesheet information of the contingent laborer;
updating, by the user device and based on the prediction, the user interface of the timesheet application to accentuate either a clock-in button or a clock-out button;
receiving, by the user device, a clock value indicating a time during which the contingent laborer is clocking-in or clocking-out;
generating, by the user device, a time-entry record based on the clock value; and
providing, by the user device, the time-entry record to the application server such that the user device and the application server have updated timesheet information for the contingent laborer.

2. The method of claim 1, wherein the application server supports a vendor management system (VMS) that is a single source of authority for the timesheet information of the contingent laborer.

3. The method of claim 1, further comprising:
obtaining, from the application server, profile information for a group of contingent laborers scheduled to work at a worksite, the profile information including a set of user identifiers where each user identifier corresponds to a respective contingent laborer;
storing the profile information for the group of contingent laborers locally on the user device; and
wherein verifying the user identifier of the contingent laborer comprises:
verifying the user identifier of the contingent laborer based on determining that the user identifier matches a corresponding stored user identifier of the set of user identifiers.

4. The method of claim 1, wherein predicting whether the contingent laborer is clocking-in or clocking-out comprises:
identifying two clock values that represent the two most recent clock values included in the one or more time-entry records,
determining whether a difference in time between the two most recent clock values is greater than a first threshold amount of time, and
in response to determining that the difference in time is greater than the first threshold amount of time, predicting that the contingent laborer is clocking-in, or
in response to determining that the difference in time is not greater than the first threshold amount of time:
determining whether a time identified by a most recent clock value is within a second threshold amount of time of a current time, and
predicting whether the contingent laborer is clocking-in or clocking-out based on determining whether the time identified by the most recent clock value is within the second threshold amount of time of the current time.

5. The method of claim 1, wherein predicting whether the contingent laborer is clocking-in or clocking-out comprises:
identifying a most recent clock value included in the one or more time-entry records,
determining whether a difference in time between the most recent clock value and a current time clock value is greater than a threshold amount of time, and
predicting whether the contingent laborer is clocking-in or clocking-out based at least in part on determining whether the difference in time is greater than the threshold amount of time.

6. The method of claim 1, wherein predicting whether the contingent laborer is clocking-in or clocking-out comprises incorrectly predicting whether the contingent laborer is clocking-in or clocking-out;
wherein the clock value that indicates the time during which the contingent laborer is clocking-in or clocking-out corresponds to whichever of the clock-in button or clock-out button is not accentuated on the user interface; and
wherein the method further comprises:
determining that a timekeeping discrepancy is present based on receiving the clock value that corresponds to whichever of the clock-in button or clock-out button is not accentuated on the user interface;
generating an exception message for the timekeeping discrepancy; and
providing the exception message to a device or account of a user authorized to correct the timekeeping discrepancy.

7. The method of claim 1, wherein the contingent laborer is scheduled to work at a worksite; and wherein the method further comprises:
periodically providing ping messages to the application server to cause the application server to update an administrator user interface of the timesheet application such that said updated administrator user interface displays information indicative of whether a network at the worksite is down.

8. The method of claim 1, further comprising:
appending the time-entry record to a list that includes the one or more time-entry records for the one or more shifts that the contingent laborer has worked in the given time period; and
wherein providing the time-entry record to the application server comprises:
providing the application server with the list that includes the appended time-entry record such that the application server has real-time access to updated timesheet information of the contingent laborer.

9. A user device for managing timesheet information of a contingent laborer, comprising:
a memory storing instructions; and
a processor that, when executing the instructions, is to:
receive a user identifier of the contingent laborer;
verify the user identifier of the contingent laborer;
obtain timesheet information of the contingent laborer from an application server, the timesheet information including one or more time-entry records for one or more shifts that the contingent laborer has worked in a given time period;
provide the timesheet information of the contingent laborer for display on a user interface;
predict whether the contingent laborer is clocking-in or clocking-out based at least in part on the timesheet information of the contingent laborer;
update, based on the prediction, the user interface of the timesheet application to accentuate either a clock-in button or a clock-out button;
receive a clock value indicating a time during which the contingent laborer is clocking-in or clocking-out;
generate a time-entry record based on the clock value; and
provide the time-entry record to the application server such that the user device and the application server have updated timesheet information for the contingent laborer.

10. The user device of claim 9, wherein the application server supports a vendor management system (VMS) that is a single source of authority for the timesheet information of the contingent laborer.

11. The user device of claim 9, wherein the processor, when predicting whether the contingent laborer is clocking-in or clocking-out, is to:
identify two clock values that represent the two most recent clock values included in the one or more time-entry records,
determine whether a difference in time between the two most recent clock values is greater than a first threshold amount of time, and
in response to determining that the difference in time is greater than the first threshold amount of time, predict that the contingent laborer is clocking-in, or
in response to determining that the difference in time is not greater than the first threshold amount of time:
determine whether a time identified by a most recent clock value is within a second threshold amount of time of a current time, and
predict whether the contingent laborer is clocking-in or clocking-out based on determining whether the time identified by the most recent clock value is within the second threshold amount of time of the current time.

12. The user device of claim 9, wherein the processor, when predicting whether the contingent laborer is clocking-in or clocking-out, is to:
identify a most recent clock value included in the one or more time-entry records,
determine whether a difference in time between the most recent clock value and a current time clock value is greater than a threshold amount of time, and
predict whether the contingent laborer is clocking-in or clocking-out based at least in part on determining whether the difference in time is greater than the threshold amount of time.

13. The user device of claim 9, wherein predicting whether the contingent laborer is clocking-in or clocking-out comprises incorrectly predicting whether the contingent laborer is clocking-in or clocking-out;
wherein the clock value that indicates the time during which the contingent laborer is clocking-in or clocking-out corresponds to whichever of the clock-in button or clock-out button is not accentuated on the user interface; and
wherein the processor is further to:
determine that a timekeeping discrepancy is present based on receiving the clock value that corresponds to whichever of the clock-in button or clock-out button is not accentuated on the user interface;
generate an exception message for the timekeeping discrepancy; and
provide the exception message to a device or account of a user authorized to correct the timekeeping discrepancy.

14. The user device of claim 9, wherein the contingent laborer is scheduled to work at a worksite; and wherein the processor is further to:
periodically provide ping messages to the application server to cause the application server to update an administrator user interface of the timesheet application such that said updated administrator user interface displays information indicative of whether a network at the worksite is down.

15. The user device of claim 9, wherein the processor is further to:
append the time-entry record to a list that includes the one or more time-entry records for the one or more shifts that the contingent laborer has worked in the given time period; and
wherein the processor, when providing the time-entry record to the application server, is to:
provide the application server with the list that includes the appended time-entry record such that the application server has real-time access to updated timesheet information of the contingent laborer.

16. A non-transitory computer-readable medium storing instructions, the instructions including:
one or more instructions that, when executed by a processor of a device, cause the processor to:
receive a request to access a timesheet application, the request including a user identifier of the contingent laborer;
verify the user identifier of the contingent laborer;
obtain timesheet information of the contingent laborer from an application server, the timesheet information including one or more time-entry records for one or more shifts that the contingent laborer has worked in a given time period;
provide the timesheet information of the contingent laborer for display on a user interface;
predict whether the contingent laborer is clocking-in or clocking-out based at least in part on the timesheet information of the contingent laborer;
update, based on the prediction, the user interface of the timesheet application to accentuate either a clock-in button or a clock-out button;
receive a clock value indicating a time during which the contingent laborer is clocking-in or clocking-out;
generate a time-entry record based on the clock value; and
provide the time-entry record to the application server such that the user device and the application server have updated timesheet information for the contingent laborer.

17. The non-transitory computer-readable medium of claim 16, wherein the one or more instructions, that cause the processor to predict whether the contingent laborer is clocking-in or clocking-out, cause the processor to:
identify two clock values that represent the two most recent clock values included in the one or more time-entry records,
determine whether a difference in time between the two most recent clock values is greater than a first threshold amount of time, and
in response to determining that the difference in time is greater than the first threshold amount of time, predict that the contingent laborer is clocking-in, or
in response to determining that the difference in time is not greater than the first threshold amount of time:
determine whether a time identified by a most recent clock value is within a second threshold amount of time of a current time, and
predict whether the contingent laborer is clocking-in or clocking-out based on determining whether the time identified by the most recent clock value is within the second threshold amount of time of the current time.

18. The non-transitory computer-readable medium of claim 16, wherein the one or more instructions, that cause the processor to predict whether the contingent laborer is clocking-in or clocking-out, cause the processor to:
identify a most recent clock value included in the one or more time-entry records,
determine whether a difference in time between the most recent clock value and a current time clock value is greater than a threshold amount of time, and
predict whether the contingent laborer is clocking-in or clocking-out based at least in part on determining whether the difference in time is greater than the threshold amount of time.

19. The non-transitory computer-readable medium of claim 16, wherein predicting whether the contingent laborer is clocking-in or clocking-out comprises incorrectly predicting whether the contingent laborer is clocking-in or clocking-out;
wherein the clock value that indicates the time during which the contingent laborer is clocking-in or clocking-out corresponds to whichever of the clock-in button or clock-out button is not accentuated on the user interface; and
wherein the one or more instructions, when executed by the processor, further cause the processor to:
determine that a timekeeping discrepancy is present based on receiving the clock value that corresponds to whichever of the clock-in button or clock-out button is not accentuated on the user interface;
generate an exception message for the timekeeping discrepancy; and
provide the exception message to a device or account of a user authorized to correct the timekeeping discrepancy.

20. The non-transitory computer-readable medium of claim 16, wherein the contingent laborer is scheduled to work at a worksite; and wherein the one or more instructions, when executed by the processor, further cause the processor to:
periodically provide ping messages to the application server to cause the application server to update an administrator user interface of the timesheet application such that said updated administrator user interface displays information indicative of whether a network at the worksite is down.
